(19) United States
(12) Patent Application Publication
(10) Pub. No.: US 2004/0080380 A1
(43) Pub. Date: Apr. 29, 2004

(54) Hybrid phase shifter and power divider

(75) Inventor: Ronald A. Marino, Jackson, NJ (US)

Correspondence Address: SUGHRUE MION, PLLC, 2100 PENNSYLVANIA AVENUE, N.W., SUITE 800, WASHINGTON, DC, 20037, US

(73) Assignee: RADIO FREQUENCY SYSTEMS; INC.

(21) Appl. No.: 10/281,995

(22) Filed: Oct. 29, 2002

(51) Int. Cl. H01P 1/18; H01P 5/18

(52) U.S. Cl. 333/161; 333/128

(57) ABSTRACT

A device for conditioning a signal includes a hybrid phase shifter and power divider. The power divider circuit includes a transmission line with an input port and two asymmetrical output ports, a first ground plane, a second ground plane, and a first dielectric region. The variable phase shifter includes the transmission line and a dielectric slab disposed to be variably positioned in the first dielectric region. The position of the dielectric slab in relation to the power divider circuit determines the amount of phase shift in the signal. With the above configuration, the invention requires much less space and reduces the number of parts and cable interconnects.

### BACKGROUND OF THE INVENTION

1. Field of the Invention

The present invention relates to a device for conditioning a signal. More particularly, the present invention relates to a hybrid phase shifter and power divider for use in antenna arrays. The invention is embodied in a device and a method for dividing the power of a signal and shifting the phase of the signal in a hybrid phase shifter and power divider.

2. Background and Related Art

The range of the electromagnetic spectrum from 300 MHz to 300 GHz is commonly referred to as the microwave range. For wavelengths from 1 meter to 1 millimeter, low frequency circuit analysis techniques can not be used and transmission-line theory must be used. In transmission-line theory, the voltage and current along a transmission line can vary in magnitude and phase as a function of position. Thus, devices suitable for microwave signals must be used.

In antennas, discrete phase shifters and power divider networks connected in series may be utilized to form the feed network for multi-element antenna arrays. This configuration may be utilized in the feed networks of electrically adjustable down-tilt antenna arrays such as those utilized in base station applications for wireless networks. Arrays of this type that incorporate feed networks utilizing discrete elements require much more space than arrays that do not include the electrical down-tilt option. As a result of using discrete components in the electrical down-tilt configuration, the cross section of the antenna will have to be widened to account for the increased number of components. Alternatively, the discrete components may be placed on both sides of the chassis and a wrap around radome may be required to enclose the mechanism and protect it from the elements. In practical applications wherein space is limited, these configurations may become problematic. For example, a communications system that requires dual band antenna arrays that include two or more feed network designs, such as dual band diversity electrical down-tilt arrays that require four separate feed networks, will require a fair amount of real estate that may not be practically available.

U.S. Pat. No. 5,075,648 (Roberts et al.) discloses a hybrid mode RF phase shifter and variable power divider. As illustrated in FIGS. 8 and 9, a miniaturized waveguide is shown comprising a variable power divider including a first phase shifter 106 and a second phase shifter 107 coupled between a Wilkinson microstrip divider 94 and a branch line 90 degree microstrip hybrid 95. The phase shifters 106 and 107 may each have a toroid structure that is suspended from the ground plane side 100 of a substrate 88. Roberts et al. does not disclose a dielectric slab that acts as a phase shifter when moved in relation to the power divider.

U.S. Pat. No. 6,075,424 (Hampel et al.) shows an article having a phase shifter including a movable dielectric element. As illustrated in FIG. 1A, the article comprises a phase-shifting member 4a, an active line comprising a microstrip line 2, and a ground plane 6 wherein the phase-shifter 4a is movable in the direction of arrow 12 in a manner such that the phase of the electrical signal transmitted through microstrip 2 is changed as a function of the amount of dielectric material passed between the ground plane and the active line. The invention disclosed by Hampel et al., however, does not disclose a hybrid phase shifter and power divider.

FIG. 13 of U.S. Pat. No. 4,117,494 (Frazita) shows an antenna coupling network including a phase adjustment mechanism comprising a conductive strip 80 disposed on a dielectric slab 78, and a toroidal shaped ferrite slab 90, wherein the ferrite slab 90 is placed over the conductive strip 80 to induce a phase adjustment in the electrical signal propagating through the conductor. Likewise, Frazita does not disclose the specific arrangement of a hybrid power divider/phase shifter utilizing a combined power divider circuit and phase shifter in the form of a movable dielectric slab.

### SUMMARY OF THE INVENTION

It is thus an object of the invention to provide a device for conditioning a signal, a device which overcomes difficulties including the above-mentioned difficulties associated with the previous devices.

The present invention relates to a hybrid power divider and a phase shifter that may be included in electrical down-tilt antenna arrays wherein the element phase is changed through the manipulation of the adjustable phase shift mechanism. The array comprises a power divider circuit utilizing a microstrip or stripline transmission lines, and a dielectric slab. The phase shifter and power divider are combined to create a hybrid component wherein the dielectric slab may be manipulated in a manner such that it may be moved in relation to the power divider to change phase of the electrical signal.

Specifically, the dielectric slab is configured to slide across the transmission line to change the phase of the electrical signal. The phase change may be measured as a function of the position of the dielectric slab in relation to the power divider circuit or the amount of the transmission line that is covered or overlapped by the dielectric slab.

In one embodiment of the present invention, multiple hybrid phase shifter and power dividers are connected in serial to form a multistage hybrid phase shifter and power divider. In another embodiment, multiple hybrid circuits that utilize stripline transmission lines may be stacked in parallel and utilized with various antenna array configurations.

The invention is realized in a method for conditioning a signal comprising dividing the power of the signal and shifting the phase of the signal. The power is divided through the first and second output ports of the transmission line and the phase of the signal is shifted by sliding a dielectric slab between a ground plane and a transmission line.

Moreover, the above method further comprises serially repeating the sequence of dividing the power and shifting the phase of the signal in a multistage hybrid phase shifter and power divider. Alternatively, the above method further comprises stacking a plurality of multistage hybrid phase shifter and power dividers in parallel.

### BRIEF DESCRIPTION OF THE DRAWINGS

Other features and advantages of the present invention will be apparent from the following description taken in connection with the accompanying drawings, wherein:

FIG. 1 is a top view of the transmission line and the dielectric slab of a hybrid phase shifter and power divider;

FIG. 2 is a perspective view of the hybrid phase shifter and power divider;

FIG. 3 is a top view of the transmission line and dielectric slabs of a multistage hybrid phase shifter and power divider;

FIG. 4 is a side view of a stacked hybrid phase shifter and power divider;

FIG. 5 is a bottom view of the reflector plate of an antenna including the hybrid phase shifter and power divider; and

FIG. 6 is a top view of the reflector plate depicted in FIG. 5.

### DETAILED DESCRIPTION OF THE PREFERRED EMBODIMENTS

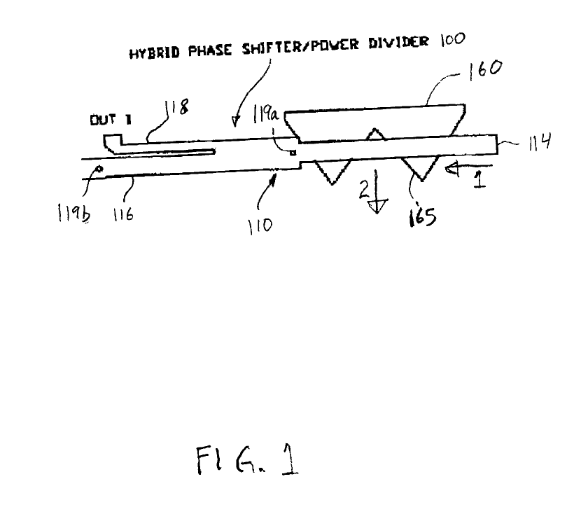

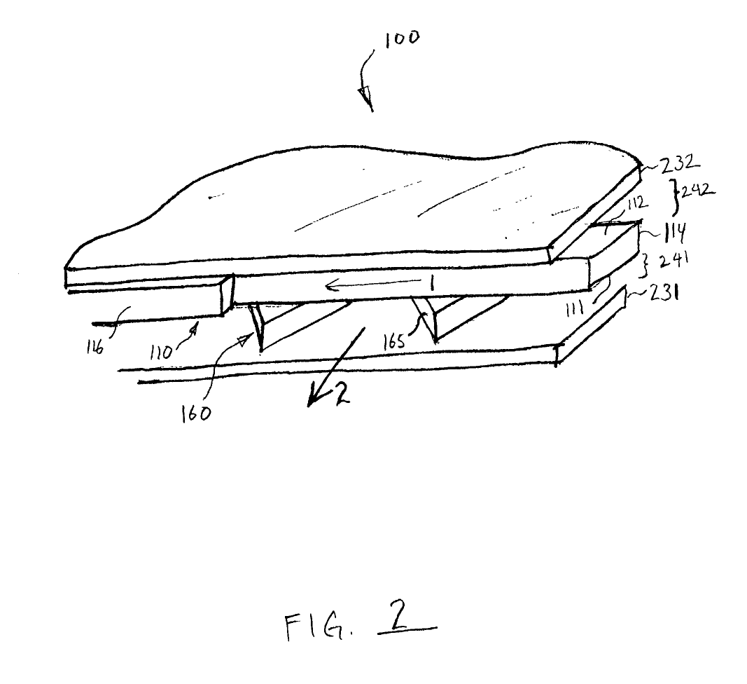

An exemplary first embodiment will now be described with reference to the drawings. FIGS. 1 and 2 show a hybrid phase shifter and power divider in the form of a first embodiment of the present invention. The device comprises a power divider made up of a transmission line 110 with an input end, an output end, a first surface 111, a second surface 112, and a first direction 1 indicating the direction of propagation of an electrical signal in the transmission line 110. In this embodiment, the transmission line is a stripline transmission line carrying a microwave signal. Alternatively, the transmission line 110 may be a microstrip transmission line. In construction, the transmission line 110 is made of stamped brass or of any other conductor. The first surface 111 and the second surface 112 are opposite surfaces of the transmission line 110. An input port 114 is disposed at the input end of the transmission line 110, and the first output port 116 and the second output port 118 are both disposed at the output end of the transmission line 110. Here, the first output port 116 and the second output port 118 are of unequal geometric size, for reasons to be explained below. Alternatively, the input port is a receiving port while the output ports are transmitting ports. Further, in another alternative embodiment, the input port is a transmitting port and the output ports are receiving ports.

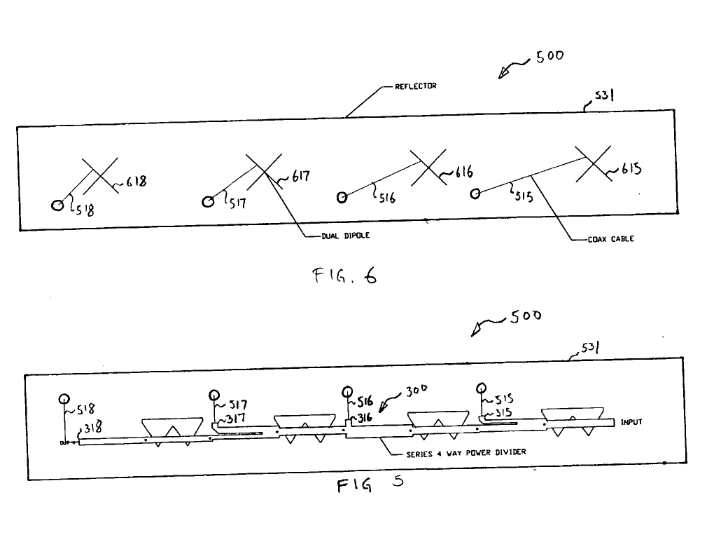

Under the transmission line 110, there is a first electrically conductive ground plane 231 and above the transmission line 110, there is a second electrically conductive ground plane 232. In between the transmission line 110 and the first electrically conductive ground plane 231, there is a first air-dielectric region 241. Likewise, there is a second air-dielectric region 242 disposed between the transmission line 110 and the second electrically conductive ground plane 232. Alternatively, the first electrically conductive ground plane 231 is a reflector plate 531 shown in FIGS. 5 and 6.

In the transmission line 110, there are holes 119a, 119b where one end of a dielectric support is attached. A second end of the dielectric support is attached on the first electrically conductive ground plane 231 to hold the transmission line 110 at a fixed distance between the first electrically conductive ground plane 231 and the second electrically conductive ground plane 232.

Further, there is a variable phase shifter comprising the transmission line 110 and a moveable dielectric slab 160 disposed to be variably positioned in the first air-dielectric region 241 along a second direction 2 perpendicular to the first direction 1, for causing a phase shift in the microwave signal. The amount of the phase shift is a function of a position of the dielectric slab 160 in relation to the transmission line 110 along the second direction 2. The slab 160 has a uniform thickness and a double triangle-shaped projecting leading edge 165 in the second direction 2 for matching impedance in the transmission line 110. The dielectric slab 160 is not limited to the described shape and can have different shapes.

The operation of this embodiment will be described in the following.

An electrical signal such as a microwave signal is input into the input port 114. As the signal travels along the transmission line 110, the dielectric slab 160 located between the transmission line 110 and the first electrically conductive ground plane 231 subjects the microwave signal in the transmission line 110 to dielectric loading, resulting in a dielectric constant for the transmission line 110. Hence, the signal is exposed to a change in the dielectric constant as the signal travels from a region without an overlapping dielectric slab 160 to a region with an overlapping dielectric slab 160. This change in the dielectric constant in the transmission line 110 results in a phase shift of the microwave signal.

The amount of the phase shift can vary depending on the amount of the dielectric slab 160 that disposed between the transmission line 110 and the first electrically conductive ground plane 231. The geometry of the double triangle-shaped projecting leading edge 165 of the dielectric slab 160 permits a gradual increase in the amount of the dielectric overlapping the transmission line 110 as the dielectric slab 160 is moved along the second direction 2 in the first air-dielectric region 241. With a gradual increase in the amount of the dielectric the dielectric constant of the transmission line 110 increases, which in turn, increases the amount of the phase shift in the microwave signal. The dielectric slab is not limited to the shape described. It is noted that the dielectric slab can be of any practical shape, as long as the dielectric loading on the transmission line varies according to the relative position of the slab with respect to the transmission line.

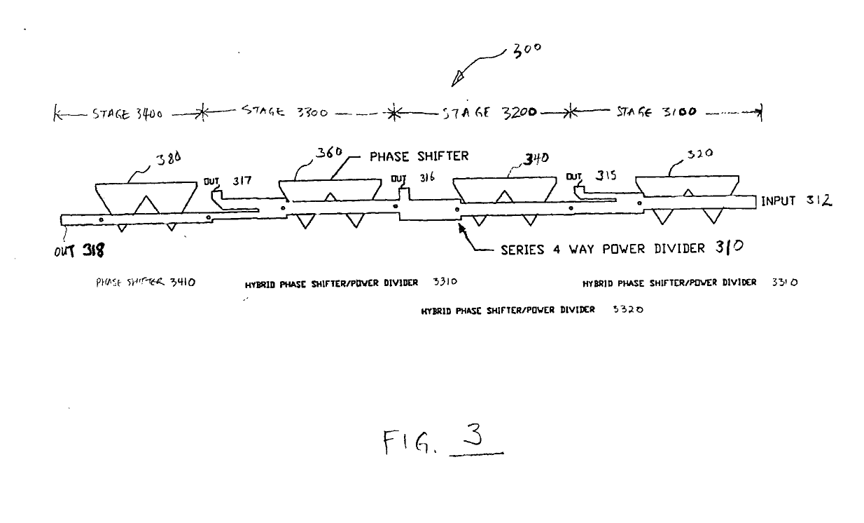

In a second embodiment of the device, a multiple number of hybrid phase shifter and power dividers are connected in series to create a multistage hybrid phase shifter and power divider. In FIG. 3, a portion of the multistage hybrid phase shifter 300 is depicted, namely, a series 4-way power divider 310 and dielectric slabs 320, 340, 360, and 380. Each of the dielectric slabs 320, 340, 360, and 380 are included in a stage of the multistage hybrid phase shifter and power divider. Namely, there are stages 3100, 3200, 3300, and 3400 which comprise a hybrid phase shifter power and divider 3110, 3232, and 3310, and a phase shifter 3410, respectively. As shown in FIG. 3, the stages 3200, 3300, and 3400 each have an input port which corresponds to an output port of a hybrid phase shifter and power divider of the preceding stage. To ensure specified power output at all output ports 315, 316, 317, and 318, the individual power dividers in stages 3100, 3200, and 3300 are asymmetrical power dividers. Although this embodiment depicts a 4-stage hybrid phase shifter and power divider, the invention can be embodied in a different number of stages. In an alternative configuration, this embodiment is a single series 4-way power divider with one input 312 and four outputs 315, 316, 317, and 318.

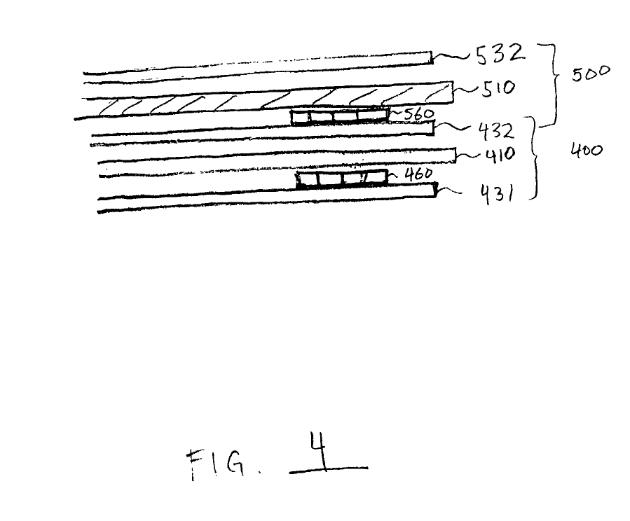

A third embodiment of the invention is shown in FIG. 4. The third embodiment has a stacked configuration of a plurality of multistage hybrid phase shifter and power dividers. Each multistage hybrid phase shifter and power divider shares one common ground plane with an adjacent multistage hybrid phase shifter and power divider in the stacked direction. For example, a multistage hybrid phase shifter 400 has a second electrically conductive ground plane 432 which is the same ground plane as the first electrically conductive ground plane 531 of a multistage hybrid phase shifter and power divider 500. Alternatively, there is a stacked configuration of single hybrid phase shifters, each sharing a common ground plane with another.

In one application, the hybrid phase shifter and power divider is used in a feed network of an antenna, as shown in FIGS. 5 and 6. FIG. 5 shows an antenna 500 including a multistage hybrid phase shifter and power divider 300 attached to the bottom of a reflector plate 531. FIG. 6 is a top view of what is depicted in FIG. 5, showing dual dipoles 615, 616, 617, and 618 disposed on the top of the reflector plate 531. Coaxial cables 515, 516, 517, and 518 are shown in FIGS. 5 and 6 to connect the output ports 315, 316, 317, and 318 of the multistage hybrid phase shifter and power divider 300, to dual dipoles 615, 616, 617, and 618, respectively. Specifically, the antenna 500 is a polarization diversity antenna that provide an electrically adjustable down-tilt by a modification of an element phase.

Consequently, much less space is required for the feed layout as a result of the phase shifter and power divider being combined in a compact hybrid package. Additionally, the hybrid phase shifter and power divider has a cost efficient design that reduces the number of parts and cable interconnects required to construct the device.

The above-mentioned antenna array can be a single band, dual band, single band diversity, or dual band diversity antenna array in a PCS, a cellular network, or any other wireless network. It is noted that the invention is applicable to other transmit and receive devices.

The invention is described in terms of the above embodiments which are to be construed as illustrative rather than limiting, and this invention is accordingly to be broadly construed. The principle upon which this invention is based can also be applied to other frequency bands of interest.

It is contemplated that numerous modifications may be made to the present invention without departing from the spirit and scope of the invention as defined in the following claims.

What is claimed is:

1. A device for conditioning a signal comprising:
a power divider circuit comprising:
a transmission line with an input end and an output end;
a input port at the input end of the transmission line;
a first output port and a second output port both disposed at the output end of the transmission line;
at least one of a first ground plane and a second ground plane;
at least one of a first dielectric region between the first ground plane and the transmission line and a second dielectric region between the second ground plane and the transmission line; and
a variable phase shifter comprising at least a part of the transmission line and a dielectric slab disposed to be variably positioned in the first dielectric region.

2. The device as claimed in claim 1, wherein the power divider circuit is one of a stripline power divider and microstrip power divider.

3. The device as claimed in claim 2, wherein:
the power divider circuit is the stripline power divider comprising the first ground plane, the second ground plane, the first dielectric region, and the second dielectric region,
the transmission line is an electrically conductive inner transmission line with a first surface and a second surface, both the first surface and the second surface are opposite surfaces of the inner transmission line, and the inner transmission line has a first direction in a propagation direction of the signal,
the first ground plane is a first electrically conductive ground plane disposed underneath the inner transmission line, and
the second ground plane is a second electrically conductive ground plane disposed above the inner transmission line.

4. The device as claimed in claim 3, wherein both the first dielectric region and the second dielectric region comprise air gaps.

5. The device as claimed in claim 4, wherein the dielectric slab is disposed to slide in the first dielectric region in a second direction perpendicular to the first direction, for causing a phase shift in the signal by an amount which is a function of a position of the dielectric slab in relation to the stripline power divider along the second direction.

6. The device as claimed in claim 5, wherein the device is a first stage hybrid phase shifter and power divider of an n-stage hybrid phase shifter and power divider connected in series.

7. The device as claimed in claim 5, wherein the device is a first device of a stacked multi-device apparatus comprising a plurality of devices each which share one common ground plane with an adjacent device.

8. A feed network for electrically adjustable down-tilt arrays of a polarization diversity antenna that provide the down-tilt by a modification of an element phase, having the hybrid phase shifter and power divider as set forth in claim 5.

9. The device as claimed in claim 5, wherein the dielectric slab is of a uniform thickness and a double triangle-shaped projecting leading edge in the second direction for matching impedance in the transmission line.

10. The device as claimed in claim 2, wherein
the power divider circuit comprises the microstrip power divider and the first ground plane,
the transmission line is an electrically conductive inner transmission line with a first surface and a second surface, both the first surface and the second surface are opposite surfaces of the inner transmission line, and the transmission line has a first direction in a propagation direction of the signal,
the first ground plane is a first electrically conductive ground plane disposed underneath the inner transmission line, and
the second ground plane is a second electrically conductive ground plane disposed above the inner transmission line.

11. The device as claimed in claim 10, wherein the first dielectric region is an air gap.

12. The device as claimed in claim 11, wherein the dielectric slab is disposed to slide in the first dielectric region in a second direction perpendicular to the first direction, for causing a phase shift in the signal by an amount which is a function of a position of the dielectric slab in relation to the microstrip power divider along the second direction.

13. The device as claimed in claim 12, wherein the device is a first stage hybrid phase shifter and power divider of an n-stage hybrid phase shifter and power divider connected in series.

14. The device as claimed in claim 12, wherein the device is a first device of a stacked multi-device apparatus.

15. A feed network for electrically adjustable down-tilt arrays of a polarization diversity antenna that provide the down-tilt by a modification of an element phase, having the hybrid phase shifter and power divider as set forth in claim 12.

16. The device as claimed in claim 12, wherein the dielectric slab is of a uniform thickness and a double triangle-shaped projecting leading edge in the second direction for matching impedance in the inner transmission line.

17. A multistage hybrid phase shifter and stripline power divider of a microwave signal in a feed network for electrically adjustable down-tilt arrays of a polarization diversity antenna that provide the down-tilt by a modification of an element phase, comprising a plurality of hybrid phase shifter and power dividers connected in series, each hybrid phase shifter and power divider comprising:
an air-dielectric stripline asymmetrical power divider, comprising:
an electrically conductive inner transmission line with a first surface and a second surface, both the first surface and the second surface are opposite surfaces of the inner transmission line, a first direction in a propagation direction of the microwave signal, an input end, and an output end;
an input port disposed at the input end of the inner transmission line;
two asymmetrical output ports disposed at the output end of the inner transmission line, comprising a first output port and a second output port;
a first electrically conductive ground plane disposed underneath the inner transmission line;
a second electrically conductive ground plane disposed above the inner transmission line;
a first air-dielectric region disposed between the first surface of the inner transmission line and the first electrically conductive ground plane; and
a second air-dielectric region disposed between the second surface of the inner transmission line and the second electrically conductive ground plane;
a variable phase shifter comprising at least a part of the air-dielectric stripline asymmetrical power divider and a moveable dielectric slab disposed to slide in the first air-dielectric region in a second direction perpendicular to the first direction, the slab with a uniform thickness and a double triangle-shaped projecting leading edge in the second direction.

18. The multistage hybrid phase divider and power divider as claimed in claim 17, wherein the multistage hybrid phase divider and power divider is a first multistage hybrid phase divider and power divider of a stacked configuration of a plurality of multistage hybrid phase divider and power dividers, each hybrid phase shifter and power divider sharing one common ground plane with an adjacent multistage hybrid phase divider and power divider in a stacked direction.

19. A method of conditioning a signal comprising:
a) dividing a power of the signal, comprising:
inputting the signal;
transmitting the signal;
dividing the power of the signal; and
b) shifting the phase of the signal, comprising:
sliding a dielectric slab in a first dielectric region between a first electrically conductive ground plane and a transmission line;
varying the amount of the phase shift by varying a position of the dielectric slab.

20. The method of claim 19, wherein the method further comprises c) serially repeating a sequence comprising a) and b), a multiple number of times to condition the signal in a multistage hybrid phase shifter and power divider.

21. The method of claim 20, wherein the method further comprises:
d) stacking a plurality of multistage hybrid phase shifter and power dividers in parallel, and
e) carrying out the sequence a plural number of times simultaneously.
